(19) United States
(12) Patent Application Publication
(10) Pub. No.: US 2010/0053027 A1
(43) Pub. Date: Mar. 4, 2010

(54) Multiple monitors

(76) Inventors: James Ian Tonnison, Oneida, NY (US); Wenxuan Tonnison, Oneida, NY (US)

Correspondence Address: BOND, SCHOENECK & KING, PLLC, ONE LINCOLN CENTER, SYRACUSE, NY, 13202-1355, US

(21) Appl. No.: 12/231,189

(22) Filed: Aug. 29, 2008

(51) Int. Cl. G09G 5/00

(52) U.S. Cl. 345/1.3

(57) ABSTRACT

A multiple monitor computer system for facilitating user multitasking via a plurality of laptop monitors or PC monitors is disclosed. In one embodiment, a two-head or three-head laptop computer is disclosed wherein the second or third laptop monitor is connected to a swivel on a rise-up component of the laptop keyboard. In another embodiment, the second or third laptop monitor is a sliding monitor that can be stored inside a monitor housing of a laptop. Portable external monitors are also disclosed that add additional display screens to existing laptops and PCs. In another embodiment, a two-head or three-head desktop computer is disclosed wherein the second or third monitor is hinged to the center monitor and can be closed to protect the screens and save desk space. And such features apply to multiple-head desktop computer. Also, a multiple desktop monitor system comprises at least one sliding monitor inside at least one desktop monitor housing, wherein the sliding monitor(s) can be pulled out for display and pushed back into the monitor housing for storage.

### BACKGROUND OF THE INVENTION

1. Field of Invention

The present invention relates to the field of computer displays for aiding computer users to view and process a high volume of information, and more particularly, to a computer system having multiple monitors.

2. Background

A number of operating systems and Internet browsers today enable a user to switch back and forth between spreadsheets, Internet pages, emails, documents, and/or various other applications. Often, it is inconvenient to switch between files and applications, especially when the user is comparing contents of different files or applications. The user has to reduce the size of file or application windows if a side-by-side comparison of different files or applications is needed. The user then needs to use scroll bars to view contents outside of the display screen due to the reduced display size. Such manual process is time consuming and confusing to the user.

Current version computers, especially laptops, have only one built-in monitor for each computer. Although a user today may attach a second desktop monitor to his laptop or PC and configure the behavior of both monitors via the computer operating system, this second monitor is bulky and cannot be easily transported. It is inconvenient for a professional who travels a lot to bring a second desktop monitor or in some cases, a second laptop with him to perform his work. Therefore, professionals normally switch between applications on one computer or laptop, a time consuming and tedious process that reduces their productivity. Also, using multiple stand-alone desktop monitors and multiple monitors of prior arts occupies a lot of desk space.

Therefore, there exists a need for a computer system to have multiple monitor screens that are portable or closable to enable a user to view and process a high volume of information to increase productivity and to save desk space.

### SUMMARY OF THE INVENTION

The purposes of the invention are to better facilitate multitasking over a plurality of computer monitors, to make it easier for individuals to perform their jobs by comparing a plurality of screens at the same time, as well as to reduced the desk space occupied by multiple desktop monitors via a closable multiple desktop or laptop monitors system. As a result, the invention helps eliminate the need to frequently switch between applications on a single screen of a laptop or personal computer, maximizes desk space, and protects monitor screens.

Specifically, the present invention provides multiple portable monitors to facilitate the computing needs of individuals. Such portable monitors can be built into a laptop, or can be stand-alone portable devices that are connected to a laptop or a PC. Also, multiple monitors can be hinged into a desktop monitor or sliding monitors can be built into a desktop monitor housing to provide maximum desk space and to protect the monitor screens. Multiple-monitor video cards allow a personal computer or laptop to utilize more than one monitor. In one embodiment of the present invention, the multiple monitors are LCD monitors that have thickness of less than one inch.

### BRIEF DESCRIPTION OF THE DRAWINGS

The present invention is illustrated by way of example and not limited in the figures of the accompanying drawings and it is to be understood that the figures provided are merely representative or illustrative and are not to scale.

FIG. 1 is an exemplary illustration of a laptop computer with a second monitor connected by a swivel.

FIG. 2 is an exemplary illustration of a laptop computer with a second sliding monitor pulled out of the laptop monitor housing.

FIG. 3 is an exemplary illustration of a portable external monitor and how its rotating feet can be rotated to support the monitor in an upright position.

FIG. 4 is an exemplary illustration of a desktop computer monitor unit with multiple monitors hinged together and how its side monitors can be closed to protect the screens and save desk space.

FIG. 5 is an exemplary illustration of a desktop computer monitor unit with multiple sliding monitors stored inside a monitor housing and these sliding monitors are pulled out of the monitor housing for display.

FIG. 6 is an exemplary illustration of a sliding monitor fitting on at least one sliding track inside a monitor housing.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention.

Various operations will be described as multiple discrete steps in turn, in a manner that is most helpful in understanding the present invention; however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

Other features of the illustrated embodiments will be apparent to the reader from the foregoing and the appended claims, and as the detailed description and discussion in conjunction with the accompanying drawings.

While the invention is described and illustrated here in the context of a limited number of embodiments, the invention may be embodied in many forms without departing from the spirit of the essential characteristics of the invention. The illustrated and described embodiments, including what is described in the abstract of the disclosure document, are therefore to be considered in all respects as illustrative and not restrictive. The scope of the invention is indicated by the appended claims rather than by the forgoing description, and all changes, which come within the meaning and range of equivalency of the claims are intended to be embraced therein.

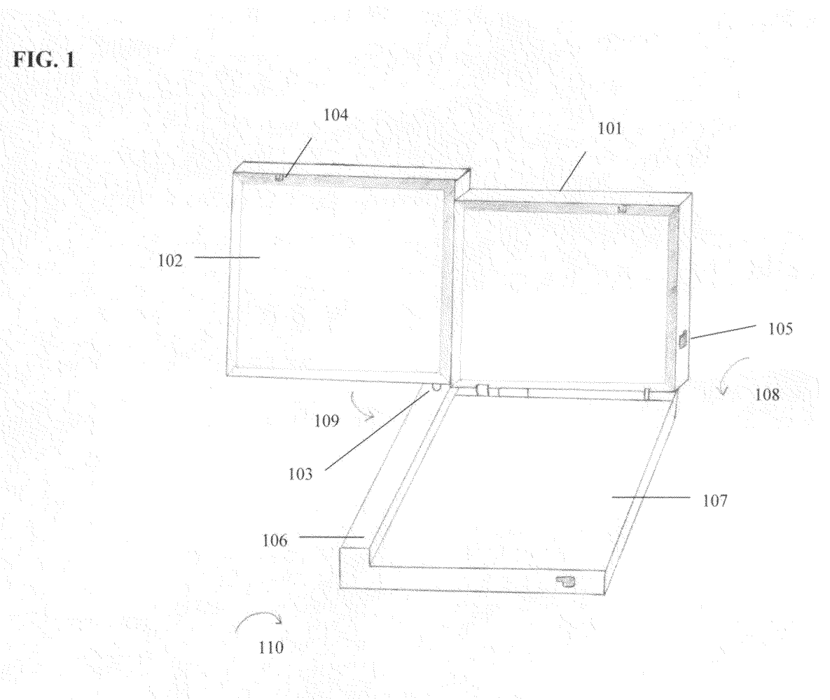

Now referring to the drawings and in particular to FIG. 1 that depicts one embodiment of the present invention wherein a second monitor is connected to a laptop computer via a swivel.

In one exemplary embodiment, FIG. 1 depicts a dual-head laptop with a second monitor connected to the laptop via a swivel mechanism on a rise-up component of the keyboard. The dual-head laptop is comprised of a first laptop monitor 101, second monitor 102, swivel 103, second monitor locking hook 104, locking hole 105 on the right side of the first laptop monitor 101, keyboard rise-up component 106, and keyboard 107. To close this dual-head laptop, first close down and lock the first monitor 101 as shown by arrow 108, then swing the second monitor so that the base of the second monitor is in line with the rise-up component as shown by arrow 109, last push down and lock the second monitor on top of the first closed monitor as shown by arrow 110.

The keyboard extension component 106 is a rise-up component, and the rise-up portion is about the same height or thickness of the first monitor 101. This rise-up component can be either at the right or left side of the laptop to hold a second monitor. Because the second monitor is connecting to this rise-up component via a swivel, when such dual-head laptop is in the closed position, the face of the second monitor is covering on the top of the first or traditional laptop monitor. There is at least one latch 104 on the second monitor to lock it to the first monitor that is revised to have at least one locking hole 105 to secure the second monitor when it's in the closed position. There is also an unlock device (not shown on FIG. 1) on the second monitor for a user to unlock the second monitor 102 from the first monitor 101 when they are at closed position. Those skilled in the art will appreciate that the rise-up extension component may not look like the solid bar shown on FIG. 1. It may be only big enough to hold the swivel to connect to the second monitor and it may be other shapes and forms.

To use such dual-head laptop, a user first unlatches the second or top monitor, pushes it up to the side, and then swings it 90 degrees so that the screen is facing the user; next, unlatches the first or bottom monitor and pushes it up like he usually does with a traditional laptop monitor. Then, he switches on his laptop to use the dual-head features. Also, at least one groove may be molded at the right side of the laptop monitor 102 to fit into at least one rise-up track on the left side of the laptop monitor 101 to further secure the laptop monitor 104 at its upright position.

A similar concept applies to include a third head on the other side of the laptop. For a three-head laptop in its closed position, the third monitor is covering on the top of the second monitor, which is on top of the first monitor. There is at least one latch on the third monitor to lock it to the second monitor that has at least one locking hole to secure the third monitor when it's in the closed position. There is also an unlock device on the third monitor for a user to unlock the third monitor from the second monitor when the three-head laptop is at closed position. To use such a three-head laptop, a user first unlatches the third monitor, pushes it up to the side, and swings it 90 degrees to face the user; unlatches the second monitor, pushes it to the other side, and swings it 90 degrees to face the user; and next, unlatches the first or bottom monitor and pushes it up like he usually does with a traditional laptop monitor. Then, he switches on his laptop to use the three-head features. The third laptop monitor may also have at least one groove on its left side that fits into at least one rise-up track on the right side of the laptop monitor 101 to further secure the third laptop monitor at its upright position.

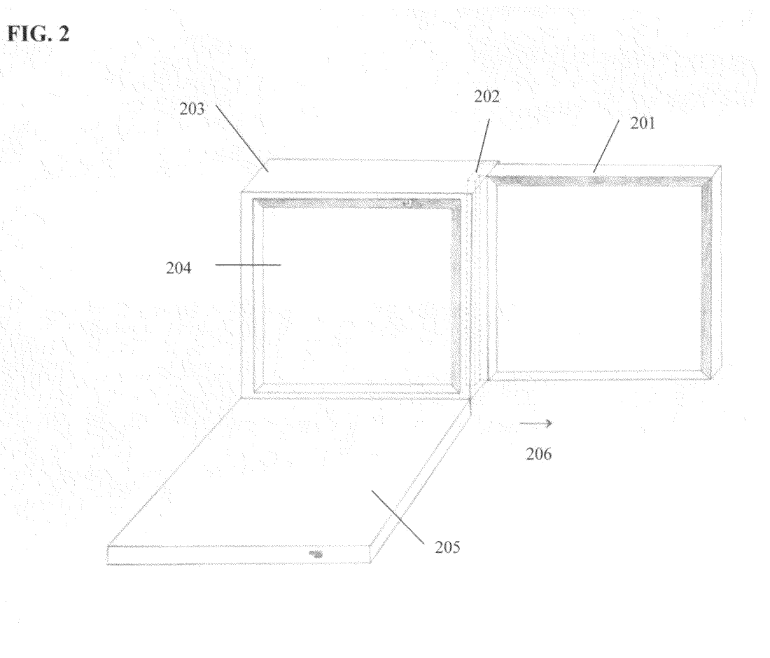

FIG. 2 depicts a dual-head laptop with a sliding second monitor built into its laptop monitor housing. Such a laptop comprises of a sliding monitor 201, docking and locking device 202, monitor housing 203, first monitor 204, and keyboard 205. A user can pull out the sliding monitor 201 as shown by arrow 206.

The sliding monitor can be built behind the first or traditional laptop monitor and there can be more than one sliding monitor stored inside the monitor housing. All monitors inside the monitor housing are integral parts of the laptop. As shown on FIG. 2, a docking and locking device 202 at the left edge of the sliding monitor connects and docks the sliding monitor to the laptop monitor housing when a user pulls the sliding monitor out to its maximum extension position. There is at least one handle or eject button (not shown in FIG. 2) on the right side of the sliding monitor to allow the user easily pull or push out the second monitor from the laptop monitor housing. To close the sliding monitor, the user simply pushes the monitor into the laptop monitor housing all the way to the end until it clicks in a locked position. The user may have an option to press an unlock button on the right side of the monitor housing to unlock the sliding monitor from its extension position and then push the monitor into the monitor housing all the way to the end until it clicks in a locked position. To pull out the second monitor, the user may also have an option to press an unlock button on the other side of the monitor housing and then pull the handle of the second monitor or simply press an eject button on the right side of the sliding monitor. The same methods apply to a third sliding monitor that can be pulled out to the left side of the laptop.

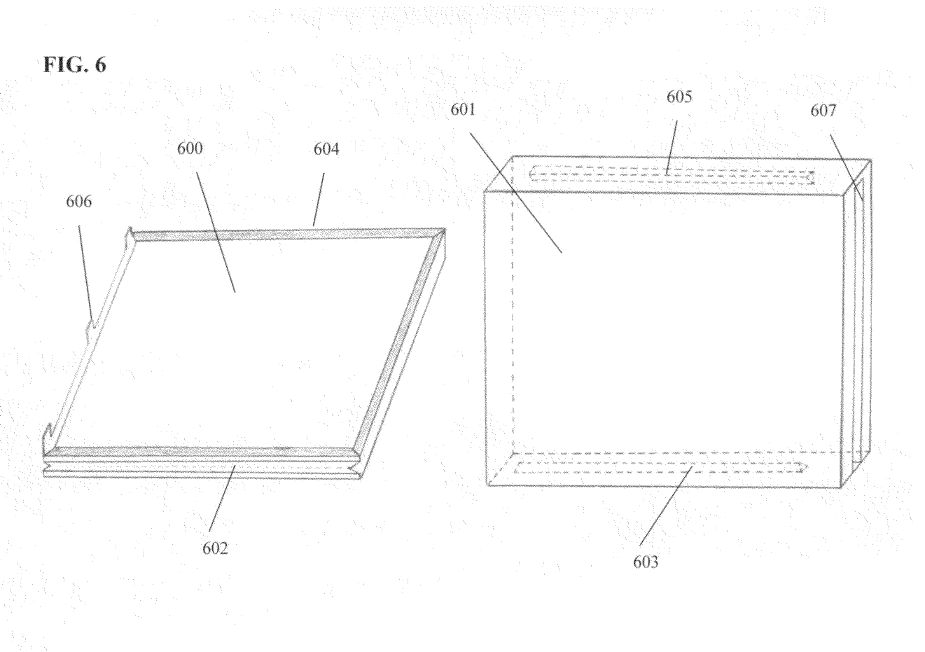

These sliding monitors can be connected to the laptop CPU via wire or wireless connections. For example, they can be connected to the laptop CPU via a Digital Video interface connection or other wired interface connection, or via wireless interface wherein wireless interface may be any wireless interface compliant with various wireless standards, such as Bluetooth or Institute of Electronics and Electrical Engineers (IEEE) 802.11 (all versions). Those skilled in the art would appreciate that the docking and locking device 202 can be in other shapes and forms. For example, it can be at least one hook on the inner side of each sliding monitor to dock and lock the sliding monitor to the monitor housing when the sliding monitor is pulled out to its maximum extension position. Each sliding monitor is sitting on at least one sliding track located on the base or under the roof of the monitor housing. Details about the sliding track are illustrated in FIG. 6.

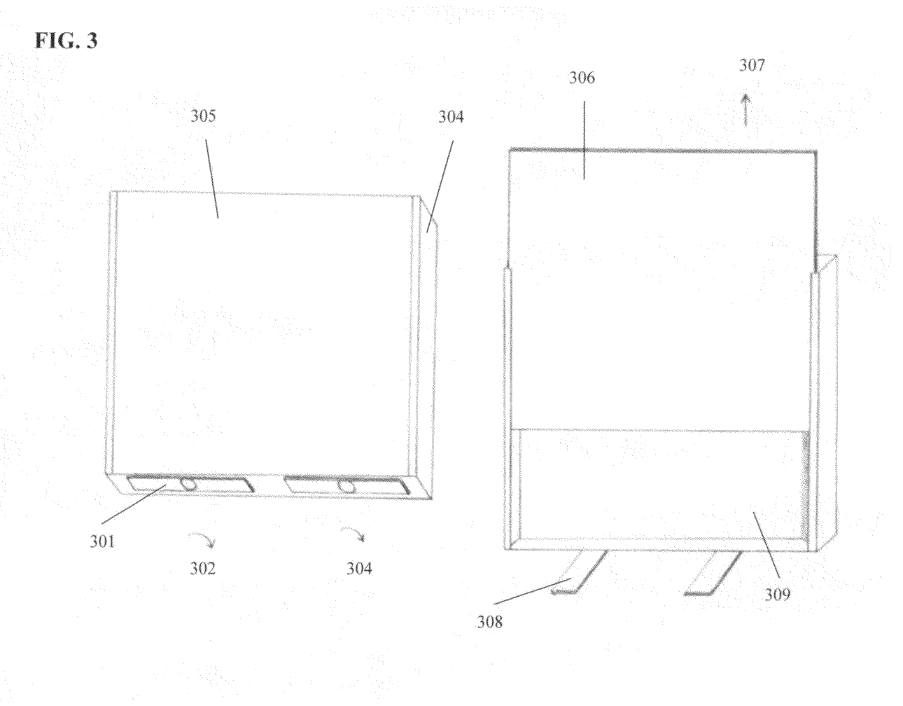

FIG. 3 depicts a portable external monitor in its closed and open positions. Such a portable external monitor 304 comprises at least one rotating foot. For this exemplarity display, we depict a portable external monitor with two rotating feet 301 at the bottom of the monitor, and a sliding cover 305 to protect the screen. The two rotating feet 301 can be turned 90 degrees as shown by arrows 302 and 304. The rotating feet that are turned 90 degrees as shown on 308 provide support for the portable monitor to stand up. Such rotating feet can also be attached to swivels so that the monitor can be adjusted to stand up on different angles according to a user's preference. The feet can be rotated back in a position parallel to the monitor bottom edge when the portable monitor is not in use. The protection cover 306 can be pulled up as shown by arrow 307 to uncover the screen 309 inside.

Such stand-alone portable monitor can be attached to a laptop's or a PC's video out connector via wire or wireless connections. For example, it can be connected to the CPU of a desktop or laptop computer via a Digital Video interface connection or other wired interface connection, or via wireless interface wherein wireless interface may be any wireless interface compliant with various wireless standards, such as Bluetooth or Institute of Electronics and Electrical Engineers (IEEE) 802.11 (all versions). A plurality of such portable monitors can be connected to a laptop or a PC. And a stand-alone portable monitor can have two screens on its two sides to allow two users viewing from opposite positions. Such a two-sided portable monitor has two sliding covers to protect its screens.

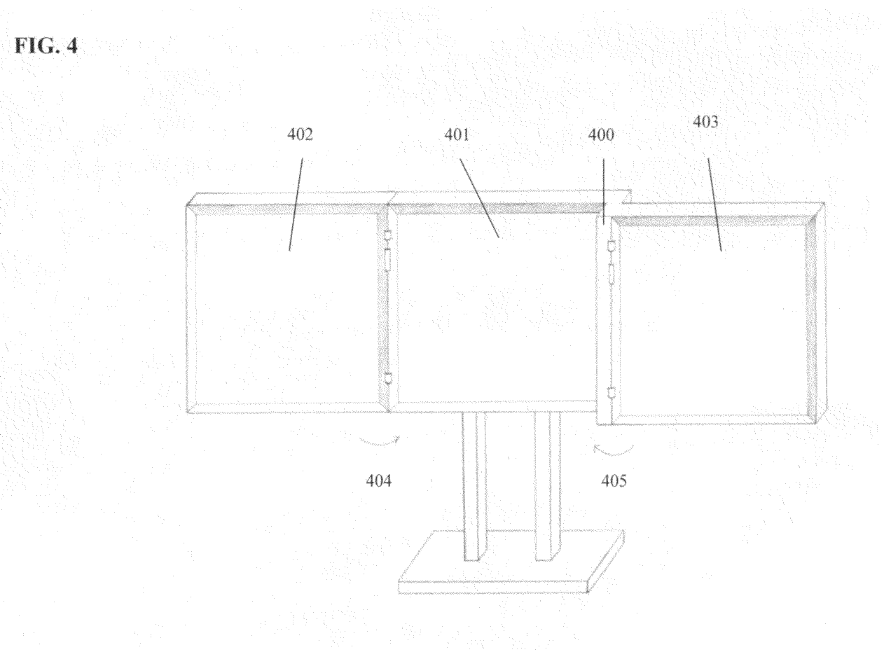

FIG. 4 depicts a stand-alone desktop device with an additional monitor or monitors hinged to a center monitor. Such a device comprises a rise-up component 400, center monitor 401, second monitor 402, and third monitor 403. To close such a device, first swing the second monitor 402 to close it in front of the center monitor as shown by arrow 404, and then swing the third monitor 403 to close it in front of the second closed monitor as shown by arrow 405.

In this exemplary embodiment, a second monitor 402 is hinged to the left side of a desktop monitor 401, which can be closed like a book to protect both monitors. A third monitor 403 can also be hinged to the other side of the desktop center monitor on a rise-up extension component of which the rise-up portion is about the thickness of the second monitor 402. Therefore, the third monitor can be closed on top of the second monitor to save space and to protect all screens when they are not being used. The rise-up extension component may not be built like the solid bar shown on FIG. 4. It may comprise at least one rise-up section or hinge that connects the third monitor 403 with the center monitor or it can be in other shapes and forms. This allows the third monitor to cover the second monitor when the three-head monitor unit is in closed position.

Similarly, the monitors depicted on FIG. 4 can be two-sided to allow users to view from opposite positions, whereby each user would have 2 to 3 screens depending on if the computer system is a four monitor unit or six monitor unit. For example, monitors 401, 402 and 403 have corresponding screens on the backside of the monitors to allow another person sitting on the other side to view. For such two-sided multiple monitors, two sliding covers may be inserted on the screens that face outside when the multiple-head computer system is in closed position, and these multiple monitors may be connected to at least one CPU via wire or wireless connections. For example, they can be connected to the desktop CPU via a Digital Video interface connection or other wired interface connection, or via wireless interface wherein wireless interface may be any wireless interface compliant with various wireless standards, such as Bluetooth or Institute of Electronics and Electrical Engineers (IEEE) 802.11 (all versions).

In addition, more monitors similar to monitors 401, 402, and 403 can be built into this multiple monitor computer system. For example, another center monitor 406 (not shown on FIG. 4) can be installed on the top of center monitor 401, which may be hinged with monitors 407 and 408 (not shown on FIG. 4) on its left and right sides, similar to how monitors 402 and 403 are hinged to center monitor 401. The functionalities of these top row monitors are the same as those of monitors 401, 402, and 403 as shown on FIG. 4. And monitors 406, 407, and 408 can also be two-sided monitors and may be protected by two sliding covers when they are at closed position.

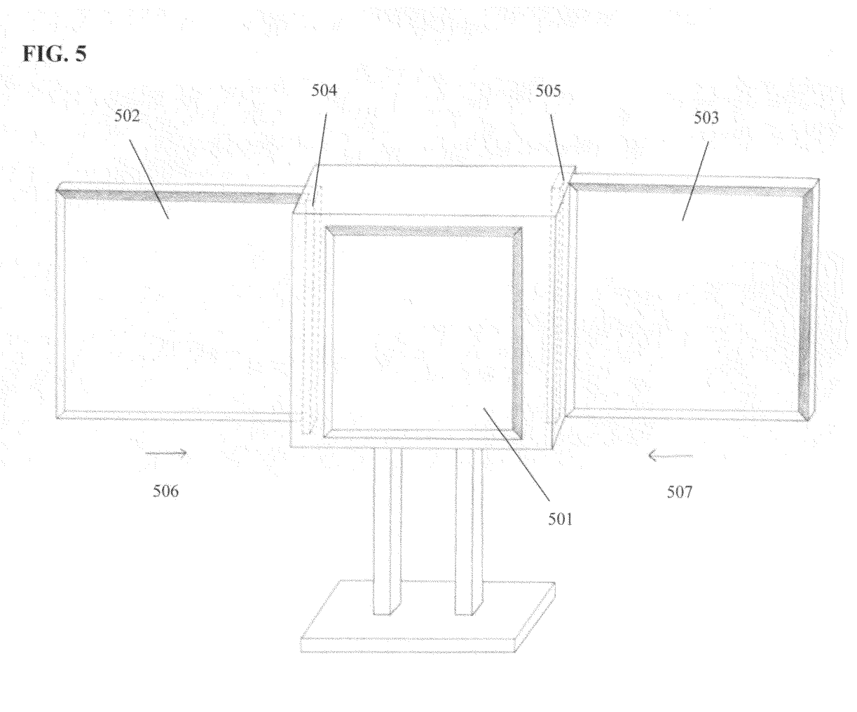

FIG. 5 depicts a stand-alone desktop device with and additional sliding monitor or monitors built into its monitor housing. Such a device comprises of a center monitor 501, left sliding monitor 502, right sliding monitor 503, docking and locking device 504 on the right side of sliding monitor 502, and docking and locking device 505 on the left side of sliding monitor 503. To close such a device, simply push both sliding monitors 502 and 503 into the monitor housing as shown by arrows 506 and 507. A removable sliding cover may also be inserted in front of the center front monitor 501 to protect the screen.

As shown on FIG. 5, a sliding monitor or multiple sliding monitors can be build behind the center monitor 501. All monitors are placed inside the desktop monitor housing as an integrated unit. Docking and locking devices 504 and 505 are built at the inner side of the sliding monitors to connect and lock the sliding monitors to the monitor housing when the sliding monitors are pulled out to their maximum extension positions. Each sliding monitor has at least a handle or an eject button to pull or push out the sliding monitor from its storage position to its maximum extension position. Also, locking and unlocking mechanisms may be provided at the right and left sides of the monitor housing to lock and unlock the sliding monitors.

Similarly, the monitors depicted on FIG. 5 can be two-sided to allow users to view from opposite positions, whereby each user would have 2 to 3 screens depending on if it is a four monitor unit or six monitor unit. For example, monitors 502 and 503 have corresponding screens on the backside of the monitors and the monitor housing has a screen on its backside to allow another person sitting on the other side to view. These multiple monitors are connected to at least one CPU via wire or wireless connections. For example, they can be connected to the desktop CPU via a Digital Video interface connection or other wired interface connection, or via wireless interface wherein wireless interface may be any wireless interface compliant with various wireless standards, such as Bluetooth or Institute of Electronics and Electrical Engineers (IEEE) 802.11 (all versions).

For such two-sided multiple monitors, two sliding covers may be inserted on the front and back of the monitor housing to protect the two opposite screens that face outside. Each sliding monitor is sitting on at least one sliding track located on the base or under the roof of the monitor housing. Details about the sliding track are illustrated in FIG. 6.

In addition, more monitors similar to monitors 501, 502, and 503 can be built into this multiple monitor computer system. For example, another center monitor 508 (not shown on FIG. 5) can be installed on the top of center monitor 501, which may have sliding monitors 509 and 510 (not shown on FIG. 5) in its monitor housing, similar to how monitors 502 and 503 are installed behind center monitor 501 inside the monitor housing. The functionalities of these top row monitors are the same as those of monitors 501, 502, and 503 as shown on FIG. 5. And monitors 508, 509, and 510 can also be two-sided monitors and may be protected by two sliding covers when they are at closed position.

FIG. 6 depicts the base of a sliding monitor 600 and how it fits on a sliding track on the base of a monitor housing 601 that has at least a front screen. To better illustrate how the sliding monitor 600 fits on the sliding track 603 of monitor housing 601, the sliding monitor 600 is shown outside of monitor housing 601. As illustrated, the base of the sliding monitor 600 has a groove 602, which allows the sliding monitor to sit on the sliding track 603 inside monitor housing 601. A similar groove may be molded on the top side of sliding monitor 600 as pointed by 604 and a similar sliding track 605 may be built under the roof of the monitor housing. Such a design secures the position of the sliding monitor and facilitates its easy push-in or pull-out operation. It is apparent to those skilled in the art that the sliding track and groove maybe in other shapes and forms, and are not limited to what's depicted on FIG. 6.

FIG. 6 also shows a different way of docking and locking the sliding monitor when it is pulled out to the maximum extension position. Instead of the docking and locking devices 202 shown on FIG. 2, and 504 and 505 shown on FIG. 5, the docking and locking devices may also look like 606 on FIG. 6, and those skilled in the art would appreciate that such docking and locking devices may be built in other shapes or forms.

The opening slot 607 on the right side of the monitor housing 601 shown on FIG. 6, allows the sliding monitor to be pulled out for display or pushed in for storage. Also, a third monitor can be installed behind sliding monitor 600 inside the monitor housing and the third monitor is also secured by at least one sliding track (not shown) behind sliding tracks 603 or 605. The opening slot (not shown) for the third monitor is located on the other side or left side of the monitor housing. The features of sliding monitors illustrated in FIG. 6 apply to both laptop and desktop monitors.

We claim:

1. A multiple monitor computer system comprising:
at least two laptop monitors, wherein said laptop monitors are connectable to a common central processing unit of said laptop; and
all laptop monitors are physically connected to said laptop computer system as components of said laptop computer system.

2. The system of claim 1, wherein a second or third laptop computer is attached to a laptop keyboard extension component via a swivel, and said keyboard extension component is a rise-up component located either at the right or left side of said laptop for a two-head laptop, or located at both sides of said laptop for a three-head laptop.

3. The system of claim 2, wherein said second laptop monitor can be swung so that its base is in parallel to the keyboard side edge, and said second laptop monitor can then be pushed down to cover a center laptop monitor when said center laptop monitor is pushed down on the keyboard at its closed position.

4. The system of claim 2, wherein said third laptop monitor can be swung so that its base is in parallel to the keyboard side edge, and said third laptop monitor can then be pushed down to cover said second laptop monitor when said second laptop monitor is pushed down at its closed position.

5. The system of claim 2, wherein said center laptop monitor has at least one locking hole to secure said second laptop monitor; said second laptop monitor has at least one latch and unlocking device to lock and unlock said second laptop monitor; and said second laptop monitor has at least one groove on its side that fits into at least one rise-up track on the adjacent side of said center laptop monitor to further secure said second laptop monitor at its upright position.

6. The system of claim 2, wherein said second laptop monitor has at least one locking hole to secure said third laptop monitor; said third laptop monitor has at least one latch and unlocking device to lock and unlock said third laptop monitor; and said third laptop monitor has at least one groove on its side that fits into at least one rise-up track on the adjacent side of said center laptop monitor to further secure said third laptop monitor at its upright position.

7. The system of claim 1, wherein at least one laptop monitor is placed inside a laptop monitor housing and behind a front laptop monitor as an integral part of said laptop and said at least one laptop monitor inside said monitor housing is a sliding monitor sitting on at least one sliding track on the base or under the roof of said monitor housing.

8. The system of claim 7, wherein said sliding monitor is connected to said laptop central processing unit via wire or wireless connections, and said sliding monitor has at least one handle or eject button to be used to pull or push said sliding monitor out of said monitor housing and said sliding monitor has at least one hook or docking device on the other side of said sliding monitor to lock and dock said sliding monitor to said monitor housing when said sliding monitor is pulled out to it its maximum extension position.

9. A multiple monitor computer system comprising:
at least one computer monitor physically connected to said computer system as an integral component of said computer system; and
at least one external portable monitor, wherein said external portable monitor is connected to said computer system via wire or wireless connection.

10. The system of claim 9, wherein said external portable monitor has at least one rotating foot that can be rotated to support said external portable monitor to stand up vertically, and said external portable monitor has a sliding cover to protect its screen.

11. The system of claim 10, wherein said rotating foot can be attached to a swivel to allow said external monitor to stand up at different angles.

12. The system of claim 9, wherein said external portable monitor can be a two-sided dual monitor to allow multiple users to view said two-sided dual monitor from opposite positions, and said two-sided dual monitor is protected by two sliding covers.

13. A multiple monitor computer system comprising:
at least two desktop monitors wherein said monitors are connected to a common central processing unit; and
said at least two desktop monitors are integral components of said computer system, and at least one of said monitors is located at the center of said computer system.

14. The system of claim 13, wherein said center monitor is hinged with at least one monitor or second monitor either at the right or left side of said center monitor, and said second monitor can be pushed to cover said center monitor similar to the action of closing a book.

15. The system of claim 14, wherein said center monitor is hinged with a third monitor on the opposite side of said second monitor, and said third monitor is hinged on an extension component at said opposite side of said center monitor, and said third monitor can be pushed to cover said second monitor when said second monitor is at closed position.

16. The system of claim 14, wherein said desktop monitors are connected to said computer system via wire or wireless connections, and said desktop monitors can be two-sided monitors to allow multiple users to view screens from opposite directions.

17. The system of claim 13, wherein at least one monitor is placed behind said center monitor and inside a monitor housing of said computer system, and said at least one monitor is a sliding monitor sitting on at least one sliding track of said monitor housing, and said sliding monitor can be pulled out from said monitor housing and pushed back into said monitor housing.

18. The system of claim 17, wherein said at least one sliding monitor is connected to said desktop computer system central processing unit via wire or wireless connections, and said sliding monitor has at least one handle or eject button to be used to pull or eject said sliding monitor out of said monitor housing, and said sliding monitor has at least one hook or docking device on the other side of said sliding monitor to lock and dock said sliding monitor to said monitor housing when said sliding monitor is pulled out to it its maximum extension position.

19. The system of claim 17, wherein said multiple monitors can be two-sided dual monitors to allow multiple users to view said two-sided dual monitors from opposite positions, and said multiple two-sided dual monitors can be connected to multiple central processing units.
